(19) United States
(12) Patent Application Publication
(10) Pub. No.: US 2014/0116232 A1
(43) Pub. Date: May 1, 2014

(54) LEARNING DEVICE FOR STRINGED MUSICAL INSTRUMENTS

(71) Applicant: Robert Cyr, Laval (CA)

(72) Inventor: Robert Cyr, Laval (CA)

(21) Appl. No.: 13/663,896

(22) Filed: Oct. 30, 2012

(51) Int. Cl. G10G 1/02; G09B 15/02

(52) U.S. Cl. 84/485 R

(57) ABSTRACT

A learning device for stringed musical instruments having a fingerboard with one or more frets, comprising a top surface having printed thereon a series of musical notes indicators and one or more perforations having dimensions and positioning corresponding to the one or more frets an a bottom surface configured to fasten the learning device to the fingerboard of the stringed musical instrument. The learning device is configured such that when it is fastened on the fingerboard below the strings of the stringed musical instrument the one or more frets protrude from the one or more perforations and the musical notes indicators are positioned at corresponding musical notes positions on the fingerboard.

### TECHNICAL FIELD

The present disclosure relates to a learning device for string musical instruments. More specifically, the present disclosure relates to a fingerboard musical notes position reminder for stringed musical instruments such as guitars or bass guitars, violins, cellos, fiddles, banjos or any other such instruments.

### BACKGROUND

Learning to play stringed musical instruments such as a guitar or bass guitar, violin, cello, fiddle, banjo and the like, can be difficult and time consuming. In general, multiple strings must be pressed against a fingerboard at one or more finger positions disposed along a neck of the musical instrument. At the same time, one or more selected strings must be vibrated via plucking, strumming or bowing, and thus, producing a musical tone, note or chord. Stringed musical instruments fingerboard do not visually indicate finger positions per se, though guitars, for example, do have visual indicators known as frets and thus use a fretboard. Nonetheless, finger positions must be memorized; one or more strings pressed at those positions against the fingerboard and selected strings caused to vibrate.

Accordingly, there is a need for a learning device for musical instruments. More specifically, the present disclosure relates to a fingerboard musical notes position reminder for stringed musical instruments.

### SUMMARY

The present disclosure provides a learning device for stringed musical instruments having a fingerboard, comprising:
a top surface having printed thereon a series of musical notes indicators; and
a bottom surface configured to fasten the learning device to the fingerboard of the stringed musical instrument;
   wherein when the learning device is fastened on the fingerboard below the strings of the stringed musical instrument the musical notes indicators are positioned at corresponding musical notes positions on the fingerboard.

There is also provided a learning device for stringed musical instruments having a fingerboard with one or more frets, comprising:
a top surface having printed thereon a series of musical notes indicators and one or more perforations having dimensions and positioning corresponding to the one or more frets; and
a bottom surface configured to fasten the learning device to the fingerboard of the stringed musical instrument;
   wherein when the learning device is fastened on the fingerboard below the strings of the stringed musical instrument the one or more frets protrude from the one or more perforations and the musical notes indicators are positioned at corresponding musical notes positions on the fingerboard.

### BRIEF DESCRIPTION OF THE FIGURES

Embodiments of the disclosure will be described by way of examples only with reference to the accompanying drawings, in which:

FIG. 1 is a detailed top view of a learning device in accordance with an illustrative embodiment of the present disclosure;

FIG. 2 is a top view of the learning device of FIG. 1 and a stringed musical instrument prior to the application of the learning device to the stringed musical instrument; and

FIG. 3 is a top view of the learning device of FIG. 1 and a stringed musical instrument after the application of the learning device to the stringed musical instrument.

Similar references used in different Figures denote similar components.

### DETAILED DESCRIPTION

Generally stated, the non-limitative illustrative embodiments of the present disclosure provide a learning device for stringed musical instruments. In a particular illustrative embodiment, the learning device is in the form of a fingerboard musical notes position reminder for stringed musical instruments. The learning device's purpose is to help the user of the stringed musical instrument find and locate the musical notes on the fingerboard. The stringed musical instrument may be, for example, a guitar or bass guitar, violin, cello, fiddle, banjo or any other such instrument.

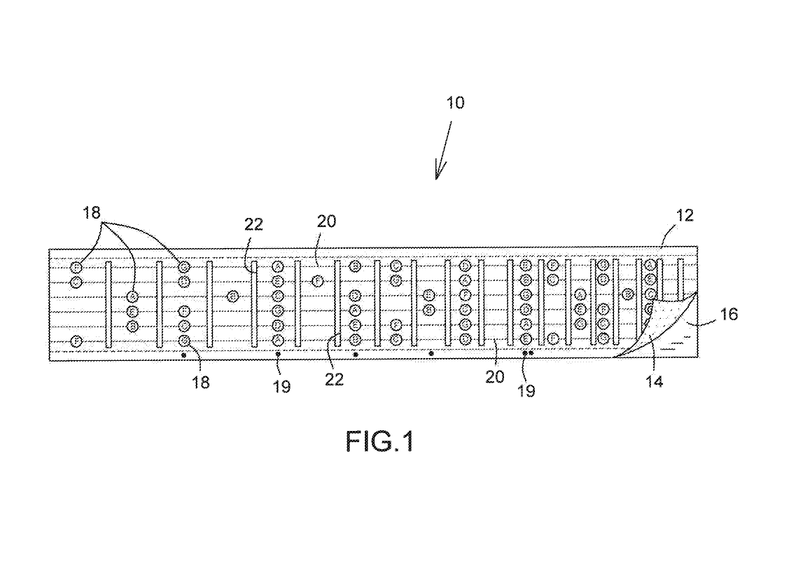

Referring to FIG. 1, the learning device 10 comprises a top surface 12 and an adhesive bottom surface 14 supported, optionally (depending on the type of material used), by a peelable non-adhesive support layer 16. The learning device 10 may be made of, for example, a self-adhesive high polymer 3D sheet, a self-adhesive vinyl carbon fiber sheet, a vinylised sticker sheet (for example MACtac™) or other removable self-adhesive films or stickers. It can be of various colors or be provided with different patterns, logos or reliefs.

On the top surface 12 of the learning device 10 are printed a series of musical notes indicators 18 and, optionally, fret indicators 19 and string position indicators 20. The learning device 10 further comprises a number of perforations 22 corresponding to the positioning of frets on a stringed musical instrument.

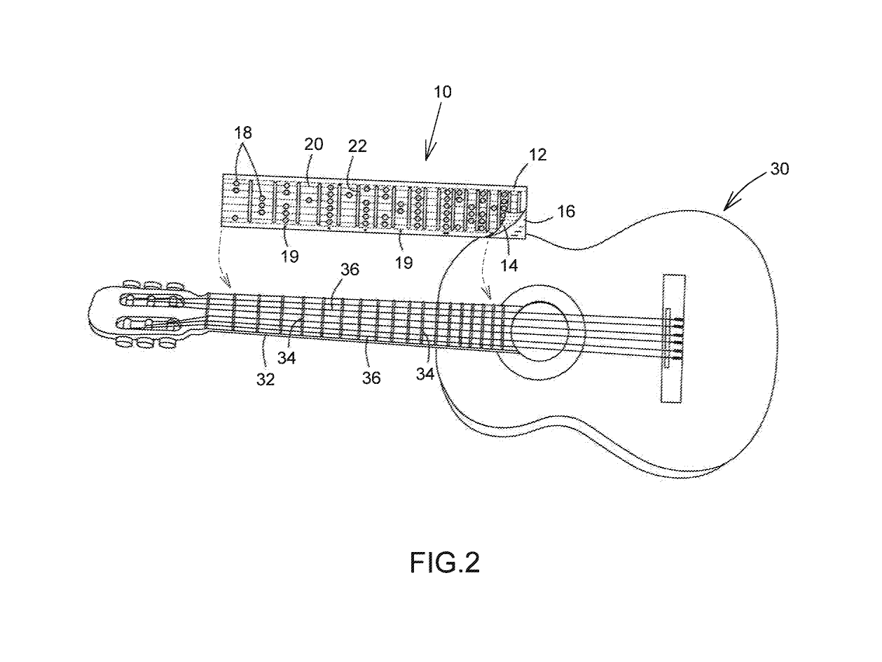

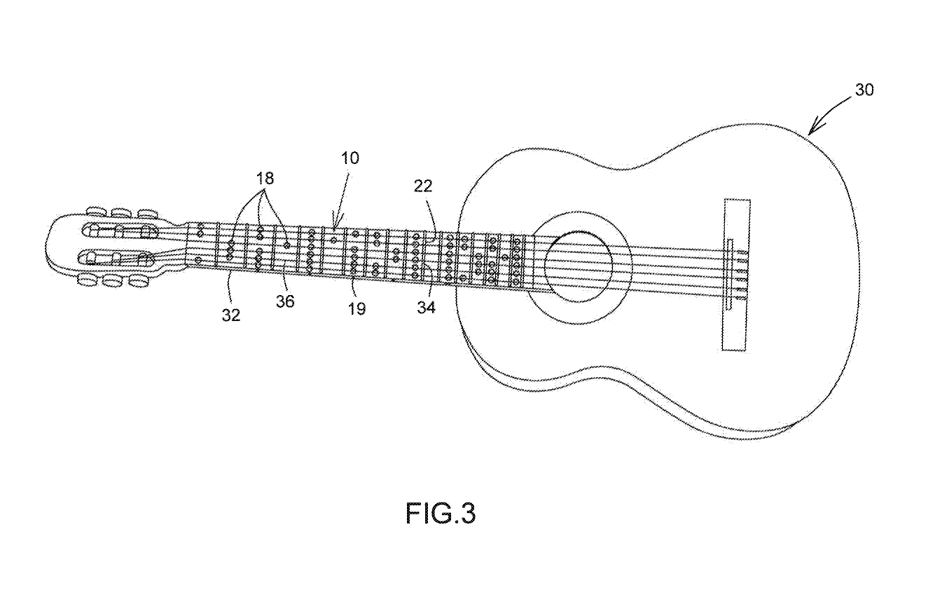

Referring to FIGS. 2 and 3, there is shown the placement of the learning device 10 onto the fingerboard 32 of a stringed musical instrument 30. If present, the support layer 16 is removed from the learning device 10 which is then slid between the fingerboard 32 and the strings 36 and then applied to the fingerboard 32, aligning it in such a way that the fret 34 of the stringed musical instrument 30 protrude through perforations 22, thus ensuring adherence of the adhesive bottom surface 14 to the fingerboard 32 and ensure correct positioning of the learning device 10. Alternatively, the support layer 16 may be only partially removed and part of the adhesive bottom surface 14 aligned and applied to the fingerboard 32, then the remaining portion of the support layer 16 is peeled while pressing the bottom surface 14 unto the fingerboard 32.

It is to be understood that the number of perforations 22 as well as their length, width and spacing may vary according to the specific type and/or model of musical stringed instrument 30 the learning device 10 is intended for (i.e. the number of frets 34 as well as their length, width and spacing for that specific type and/or model of musical stringed instrument 30). It is also to be understood that in the case of a stringed musical instrument that does not have any frets, the learning device 10 may be provided without any perforations 22. It is also to be understood that the general dimensions and positions of the various indicators 18, 19 and 20 will vary depending on the specific type and/or model of musical stringed instrument the learning device 10 is intended for.

In the illustrative embodiment, the musical notes indicators 18 are a combination of letters (i.e. CDEFGAB) and colors corresponding to the musical notes positioned at their appropriate places (depending on the specific type and/or model of musical stringed instrument) in order to help a user remember each musical note. It is to be understood that in alternative embodiments the musical notes indicators 18 may be any combinations of letters, numbers, symbols, geometric shapes, colors, etc., and that they may also correspond to a sequence of musical notes associated with a specific musical composition.

If present, the optional fret indicators 19 indicate, for example, the 3rd, 5th, 7th, 9th and 12th fret as per a standard guitar.

In an alternative embodiment, the learning device 10 may be made of plastic or other such material and mechanically attached to the fingerboard 32 of the stringed musical instrument 30. To this end, the bottom surface 14 may be provided with mechanical fasteners, for example flexible sidewalls, straps, etc., instead of an adhesive in order to fasten the leaning device 10 to the fingerboard 32.

It is to be understood that the maximum thickness of the learning device 10 may vary depending on the space available between the strings 36 and fingerboard 32, and, if present, the height of the frets 34, so as not to hinder musical play.

Although the present disclosure has been described with a certain degree of particularity and by way of an illustrative embodiments and examples thereof, it is to be understood that the present disclosure is not limited to the features of the embodiments described and illustrated herein, but includes all variations and modifications within the scope and spirit of the disclosure as hereinafter claimed.

I claim:

1. A learning device for stringed musical instruments having a fingerboard, comprising:
a top surface having printed thereon a series of musical notes indicators; and
a bottom surface configured to fasten the learning device to the fingerboard of the stringed musical instrument;
wherein when the learning device is fastened on the fingerboard below the strings of the stringed musical instrument the musical notes indicators are positioned at corresponding musical notes positions on the fingerboard.

2. A learning device in accordance with claim 1, wherein the bottom surface is provided with an adhesive.

3. A learning device in accordance with claim 2, further comprising a peelable support layer in contact with the adhesive bottom surface.

4. A learning device in accordance with claim 1, wherein the bottom surface is provided with mechanical fasteners.

5. A learning device in accordance with claim 1, further comprising one or more perforations having dimensions and positioning corresponding to associated one or more frets on the fingerboard of the stringed musical instrument.

6. A learning device in accordance with claim 5, wherein the top surface further comprises fret indictors.

7. A learning device in accordance with claim 1, wherein the musical notes indicators are selected from a group consisting of letters, numbers, symbols, geometric shapes, colors and any combination thereof.

8. A learning device in accordance with claim 1, wherein the musical notes indicators follow a specific musical composition.

9. A learning device in accordance with claim 1, wherein the top surface further comprises string indictors.

10. A learning device in accordance with claim 1, wherein the learning device is made of a material selected from the group consisting of a self-adhesive high polymer 3D sheet, a self-adhesive vinyl carbon fiber sheet and a vinylised sticker sheet.

11. A learning device for stringed musical instruments having a fingerboard with one or more frets, comprising:
a top surface having printed thereon a series of musical notes indicators and one or more perforations having dimensions and positioning corresponding to the one or more frets; and
a bottom surface configured to fasten the learning device to the fingerboard of the stringed musical instrument;
wherein when the learning device is fastened on the fingerboard below the strings of the stringed musical instrument the one or more frets protrude from the one or more perforations and the musical notes indicators are positioned at corresponding musical notes positions on the fingerboard.

12. A learning device in accordance with claim 11, wherein the bottom surface is provided with an adhesive.

13. A learning device in accordance with claim 12, further comprising a peelable support layer in contact with the adhesive bottom surface.

14. A learning device in accordance with claim 11, wherein the bottom surface is provided with mechanical fasteners.

15. A learning device in accordance with claim 11, wherein the top surface further comprises fret indictors.

16. A learning device in accordance with claim 11, wherein the musical notes indicators are selected from a group consisting of letters, numbers, symbols, geometric shapes, colors and any combination thereof.

17. A learning device in accordance with claim 11, wherein the musical notes indicators follow a specific musical composition.

18. A learning device in accordance with claim 11, wherein the top surface further comprises string indictors.
